(19) United States
(12) Patent Application Publication
(10) Pub. No.: US 2010/0039224 A1
(43) Pub. Date: Feb. 18, 2010

(54) BIOMETRICS INFORMATION MATCHING APPARATUS, BIOMETRICS INFORMATION MATCHING SYSTEM, BIOMETRICS INFORMATION MATCHING METHOD, PERSON AUTHENTICATION APPARATUS, AND PERSON AUTHENTICATION METHOD

(76) Inventors: Kazuhiro OKUDE, Hyogo (JP); Yoshiji Ishizuka, Hyogo (JP)

Correspondence Address: WENDEROTH, LIND & PONACK, L.L.P., 1030 15th Street, N.W.,, Suite 400 East, Washington, DC, 20005-1503, US

(21) Appl. No.: 12/470,902

(22) Filed: May 22, 2009

(30) Foreign Application Priority Data
May 26, 2008 (JP) 2008-137160
May 30, 2008 (JP) 2008-143041

(51) Int. Cl. G06F 7/04

(52) U.S. Cl. 340/5.83

(57) ABSTRACT

An occupant authentication apparatus is incorporated in a vehicle. The occupant authentication apparatus includes a communication processor, a biometric-data obtaining unit, a matching unit, and an association processor. The biometric-data obtaining unit obtains biometric data of an occupant of the vehicle. The communication processor communicates with a portable terminal device, and receives biometric data held by the portable terminal device. The matching unit matches the biometric data of the occupant obtained by the biometric-data obtaining unit with the biometric data that the communication processor receives from the portable terminal device. When the obtained biometric data matches the received biometric data, the association processor associates the occupant (or a seat position of the occupant), from whom the biometric data is obtained, with the portable terminal device, from which the biometric data is received.

### CROSS-REFERENCE TO RELATED APPLICATIONS

This application is based upon and claims the benefit of priority from Japanese Patent Application No. 2008-137160, filed on May 26, 2008; and Japanese Patent Application No. 2008-143041, filed on May 30, 2008, the entire contents of which are incorporated herein by reference.

### BACKGROUND OF THE INVENTION

1. Field of the Invention

The present invention relates to a technique for matching biometrics information and authenticating a person by associating a portable terminal device with a user thereof.

2. Description of the Related Art

Conventionally, biometrics information such as a fingerprint, a palm pattern, a facial image, a retinal pattern, and a voice pattern is utilized for individual authentication. According to such biometrics matching techniques, the biometrics information obtained from a user is matched with patterns registered in advance. The application range of the biometrics matching techniques is expanding, and application of the techniques to in-vehicle devices has also been studied.

Meanwhile, along the development of communication techniques in recent years, communication terminals, particularly portable telephones, have become popular very rapidly, and their functions have been developed remarkably. One of expanding portable terminal functions which attract attentions is a function of coordinating the operations of a vehicle and portable telephone by connecting the portable terminal and in-vehicle devices by cable or by radio.

One technique for coordinating the operations of a vehicle and portable terminal is described in Japanese Patent Application Laid-open No. 2007-126961. According to this technique, biometrics information is obtained from the camera of a portable telephone; the obtained biometrics information is transmitted to a vehicle; and an in-vehicle device is activated when biometric authentication is successful. Japanese Patent Application Laid-open No. 2005-170338 discloses a technique for controlling air-conditioning of a vehicle interior and an in-vehicle audio device according to instructions from a portable telephone. Japanese Patent Application Laid-open No. 2006-168553 discloses a technique for recognizing an image by an in-vehicle camera and granting use permission of an in-vehicle device when the recognized image matches an image registered in advance. Japanese Patent Application Laid-open No. 2005-290739 discloses a technique for transmitting biometrics information obtained by a portable telephone to in-vehicle devices.

On the other hand, car navigation systems have also become popular recently. It has become increasingly common for the automobile to be equipped with an in-vehicle device for playing music and video, and displaying navigation information, for example. Such in-vehicle devices have come to have a function for communicating with a portable communication terminal device such as a portable telephone and a personal digital assistant (PDA) carried by an occupant. Thus, the portable communication terminal device and the in-vehicle device can transmit and receive data therebetween.

As a radio communication standard applied to such communication between communication devices, Bluetooth® is well-known. Bluetooth® is a radio communication standard using frequency bandwidth of 2.4 gigahertz [GHz], and enables a radio communication within a radius range of a few tens of meters.

As the portable communication terminal devices become increasingly popular, many users often bring more than one communication terminal device inside the vehicle. When many communication terminal devices are present, correspondence between owners of the devices and the devices is not clear. Thus, the user-friendliness of the portable communication terminal device is still not at a satisfactory level.

The correspondence between persons and communication terminal devices in a vehicle is taken into consideration in Japanese Patent Application Laid-open No. 2007-249478. According to the technique described in this document, an electric-wave detector or the like detects the state of use of a portable telephone to check whether the portable telephone is in use, and a camera takes a picture to check whether the user of the portable telephone is a driver or not. If the result of detection shows that the driver is using the portable telephone, warning is given.

The conventional techniques, however, have various drawbacks. Firstly, when the portable communication terminal device and the in-vehicle device are designed to be connected by a cable, cable connection has to be established every time data stored in the portable communication terminal device is used. Furthermore, limited physical length of a connection cable necessitates the setting of the portable communication terminal device in a fixed cradle.

Secondly, when the in-vehicle device and the portable terminal are designed to be connected by radio, and more than one connectable portable terminal is present, the in-vehicle device needs to automatically recognize which data of which terminal device is to be used.

For example, when a driver-directed service such as a mirror-angle adjustment is to be performed, data to be used in the service has to be data stored in the portable terminal of the driver. However, it is difficult to determine which portable terminal is the portable terminal of the driver.

Thirdly, when a rental vehicle or the like is used, authentication information (in other words, biometrics information) is not registered in an in-vehicle device. Therefore, it is not possible to use coordination functions between the portable terminal and the in-vehicle device. Even when the portable terminal stores the data for the vehicle therein, such data cannot be utilized.

Fourthly, when a person is not holding a communication terminal in his/her hand, it is impossible to identify the communication terminal corresponding to this person (i.e., the communication terminal owned by this person). Therefore, even when the communication terminal stores useful information for the vehicle setting or contents usable in the vehicle, the information or the contents cannot be effectively used.

Lastly, there is a problem related with recently-developed functions such as a hands-free communication function and an e-mail reading function. These functions allow a user to use the portable telephone in such a manner that the use of the portable telephone does not obstruct the driving of the vehicle. To use these functions when plural portable telephones are present in the vehicle, it is necessary to determine which portable telephone is the target of these functions. For this purpose as well, a technique for recognizing the correspondence between the portable telephone (i.e., communication terminal) and the occupant (i.e., person) is useful.

### SUMMARY OF THE INVENTION

It is an object of the present invention to at least partially solve the problems in the conventional technology.

According to one aspect of the invention, a biometrics information matching apparatus includes a biometrics information obtaining unit that obtains biometrics information of an occupant, a communicating unit that receives biometrics information stored in a terminal device by communicating with the terminal device, or biometrics information obtained by the terminal device, a matching unit that matches the biometrics information obtained by the biometrics information obtaining unit with the biometrics information received by the communicating unit, and an association setting unit that specifies that the terminal device is a terminal device of the occupant when two pieces of biometrics information match each other as a result of matching by the matching unit.

According to another aspect of the invention, a person authentication apparatus includes a person detecting unit that detects a person by image recognition, a communication-terminal detecting unit that detects a communication terminal by radio communication, and a correspondence determining unit that determines a correspondence between the person and the communication terminal by comparing a position of the person detected by the person detecting unit with a position of the communication terminal detected by the communication-terminal detecting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a biometrics information matching system according to a first embodiment of the present invention;

FIG. 2 is a schematic diagram for explaining a detailed example of a biometric-data obtaining unit shown in FIG. 1;

FIG. 3 is a schematic diagram for explaining associating of a portable terminal device using biometric data;

FIG. 4 illustrates specific examples of biometric-data obtaining methods and corresponding services;

FIG. 5 is a flowchart for explaining operations of the biometrics information matching system according to the first embodiment;

FIG. 6 is a schematic configuration diagram of a biometrics information matching system according to a second embodiment of the present invention;

FIG. 7 is a flowchart for explaining operations of the biometrics information matching system according to the second embodiment;

FIG. 8 is a schematic configuration diagram of an occupant authentication apparatus according to another embodiment of the present invention;

FIG. 9 is a schematic diagram for explaining detection of an occupant by image recognition;

FIG. 10 is a schematic diagram for explaining detection of the position of a portable terminal device based on a comparison of strengths of reception waves;

FIG. 11 is a schematic diagram for explaining service control based on a correspondence between a person and a portable terminal device;

FIG. 12 is a flowchart for explaining a process operation of an occupant authentication apparatus according to another embodiment of the present invention;

FIG. 13 is a flowchart for explaining a detail of an occupant detecting process;

FIG. 14 is a flowchart for explaining a detail of a portable-terminal detecting process;

FIG. 15 is a flowchart for explaining a detail of a correspondence determining process; and

FIG. 16 is a flowchart for explaining a detail of an occupant-tracking determining process.

### DETAILED DESCRIPTION OF THE PREFERRED EMBODIMENTS

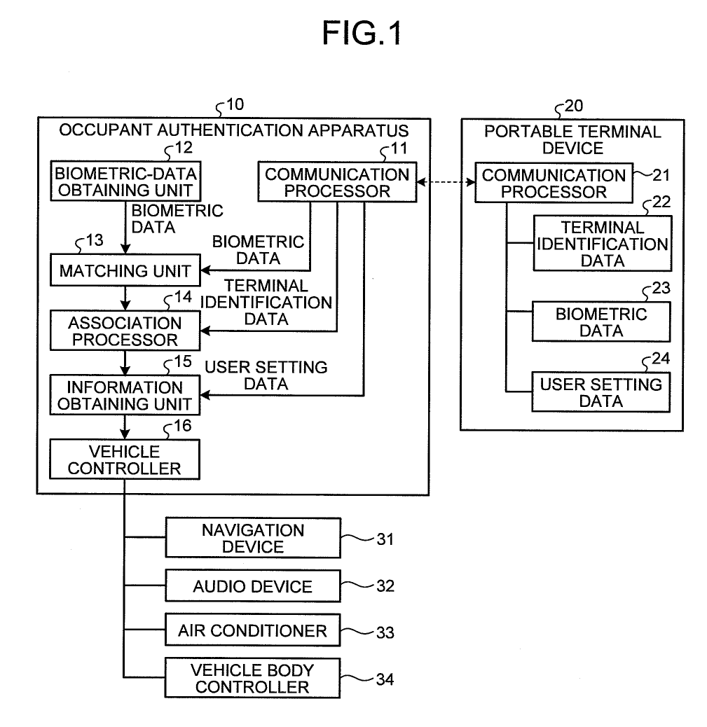

FIG. 1 is a schematic configuration diagram of a biometrics information matching system according to a first embodiment of the present invention. The biometrics information matching system depicted in FIG. 1 is an in-vehicle device, and includes an occupant authentication apparatus 10 functioning as a biometrics information matching apparatus, and a portable terminal device 20.

The portable terminal device 20 is a terminal device which can be carried by a user. The portable terminal device 20 may have any functions: for example, the portable terminal device 20 may have functions of a portable telephone. The portable terminal device 20 has a communication processor 21 as a particularly important constituent element of the present invention. The communication processor 21 establishes connection for communication with the occupant authentication apparatus 10 incorporated in a vehicle. The communication can be realized by a wired connection, or by a wireless connection such as Bluetooth®. Wireless connection allows for an automatic connection, and therefore is more convenient.

The communication processor 21 can transmit terminal identification data 22, biometric data 23, and user setting data 24, by communicating with the occupant authentication apparatus 10.

The terminal identification data 22 is identification information for identifying the own terminal (i.e., for identifying each portable terminal device 20), and the biometric data 23 is biometric data of a user of the portable terminal device 20. A fingerprint, a palm pattern, a facial image, a retinal pattern, and a voice pattern can be used as the biometric data. The biometric data 23 may be externally input to the portable terminal device 20 and stored therein in advance. Alternatively, the portable terminal device 20 may include a biometric-data obtaining unit to obtain the biometric data 23. The user setting data 24 is information relevant to the setting of a vehicle. When the user of the portable terminal device 20 uses the vehicle, the user setting data 24 is applied to the vehicle.

The occupant authentication apparatus 10 includes a communication processor 11, a biometric-data obtaining unit 12, a matching unit 13, an association processor 14, an information obtaining unit 15, and a vehicle controller 16.

The communication processor 11 establishes connection for communication with the portable terminal device 20. The biometric-data obtaining unit 12 is a processor that obtains biometric data from a vehicle occupant. A fingerprint, a palm pattern, a facial image, a retinal pattern, and a voice pattern can be used as the biometric data, as in the portable terminal device 20.

The matching unit 13 matches biometric data of a vehicle occupant obtained by the biometric-data obtaining unit 12 with biometric data that the communication processor 11 receives from the portable terminal device 20. When the obtained biometric data matches the received biometric data, the association processor 14 performs a process of associating an occupant (or a seat position of the occupant), from whom the biometric data is obtained, with the portable terminal device, from which the biometric data is received.

The information obtaining unit 15 receives the user setting data 24 from the portable terminal device 20, which is associated with the occupant. The vehicle controller 16 functions as a service operating unit that controls a vehicle and an in-vehicle device based on the received user setting data 24.

Specifically, the vehicle controller 16 performs processes for controlling operations of a navigation device 31, an audio device 32, an air conditioner 33, and a vehicle body controller 34.

The navigation device 31 specifies position information of the own vehicle by a global positioning system (GPS) artificial satellite or the like, guides the vehicle to a destination, and provides traffic and regional information. The audio device 32 is an in-vehicle device that reproduces music data and video data, and receives radio and television broadcasting. The air conditioner 33 is an in-vehicle device that executes air-conditioning such as cooling and heating of the vehicle interior. The vehicle body controller 34 controls various in-vehicle devices to adjust a seat position, angle and height of a seat, and angle of a room mirror and side mirrors, as well as the height and angle of a steering wheel.

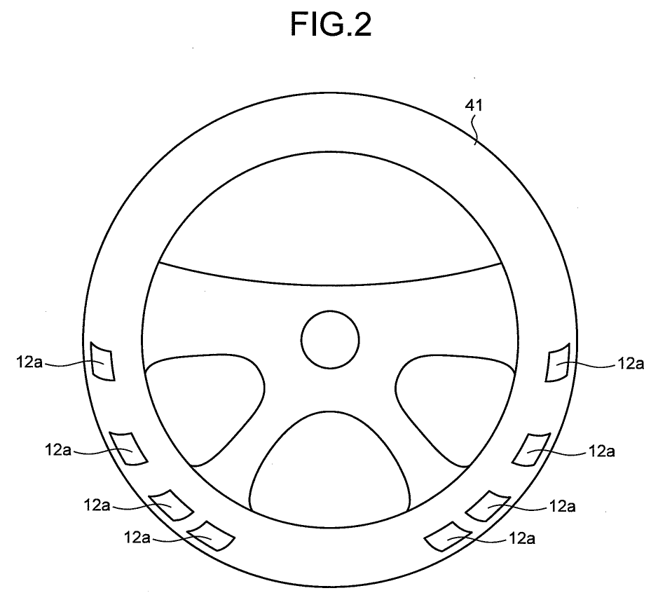

A detailed example of the biometric-data obtaining unit 12 is explained next. The biometric-data obtaining unit 12 may be a fingerprint sensor 12a provided on a steering wheel 41 as depicted in FIG. 2, for example. Because only a driver is expected to touch the steering wheel 41, biometric data (i.e., fingerprint) obtained from the fingerprint sensor 12a provided on the steering wheel 41 can be considered as the fingerprint of the driver (i.e., occupant in a driving seat).

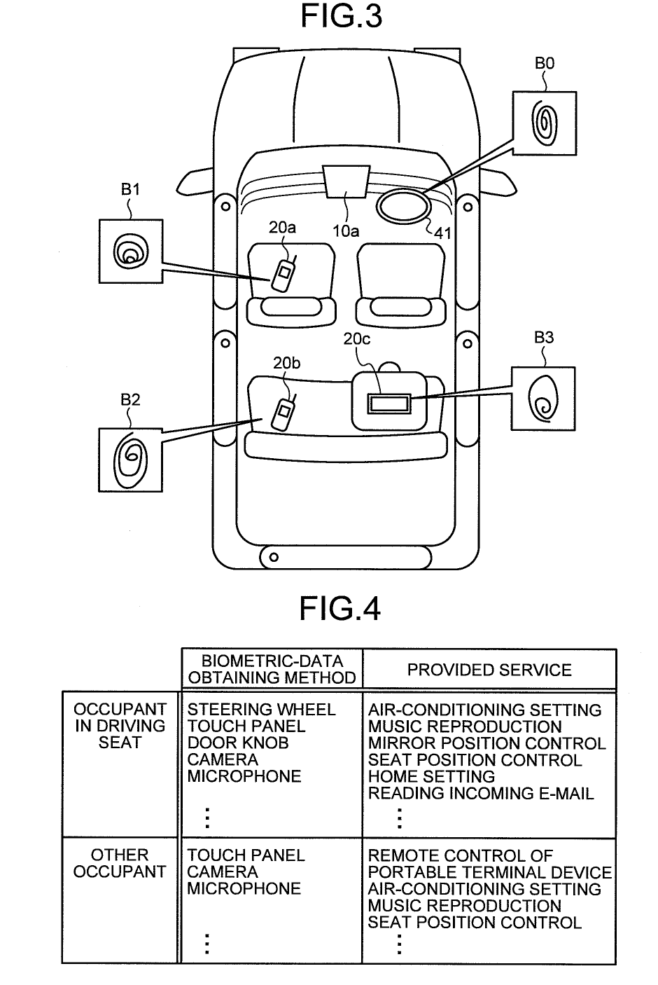

Therefore, as depicted in FIG. 3, for example, even when more than one portable terminal device is present in the vehicle, a portable terminal device holding the same biometric data as that obtained from the steering wheel 41 can be authenticated as a portable terminal device of the driver. The state of the vehicle can be adjusted to match the driver, by the information read from the portable terminal device of the driver.

In the detailed example illustrated in FIG. 3, a portable telephone 20a as a portable terminal device is present at a front passenger seat, a portable telephone 20b as a portable terminal device is present at a rear passenger seat, and a PDA terminal device 20c is present in a bag placed on a rear passenger seat. An occupant authentication apparatus 10a establishes a radio communication connection with the portable telephones 20a, 20b, and the PDA terminal device 20c, respectively. Biometric data B0 obtained from the fingerprint sensor provided on the steering wheel 41 is compared with biometric data B1 to B3 obtained from each portable terminal device. In the example illustrated in FIG. 3, the biometric data B2 matches the biometric data B0. Therefore, the portable telephone 20b as a transmitter of the biometric data B2 is the portable terminal device of the driver.

In this example, while a fingerprint is obtained from the steering wheel, and the driver is associated with a portable terminal device, a method of obtaining biometric data is not limited to obtaining of a fingerprint from a steering wheel. This method can be similarly applied to occupants other than the driver.

FIG. 4 illustrates specific examples of biometric-data obtaining methods and corresponding services. As depicted in FIG. 4, as biometric-data obtaining methods for obtaining biometric data from an occupant in a driving seat, there are a method of obtaining a fingerprint or a palm pattern from a steering wheel, a touch panel, and a door at a driving seat side, imaging a face of an occupant in a driving seat by a camera, and obtaining voices (voice patterns) by a microphone. On the other hand, for occupants other than the occupant in the driving seat, biometric data of these occupants can be obtained by obtaining a fingerprint or a palm pattern from a touch panel, imaging faces of the occupants by a camera, and obtaining voices (voice patterns) by a microphone.

As services to be provided to the occupant in the driving seat, the following services can be operated: setting and control of the air conditioner 33 by using setting information stored in a portable terminal device; reproduction of contents such as music stored in a portable terminal device; mirror position control and seat position (including angle) control by the vehicle body controller 34 by using setting information stored in a portable terminal device; transmission of a home location stored in a portable terminal device to the navigation device 31; and reading of an incoming e-mail of a portable terminal device.

As services to be provided to occupants other than the occupant in the driving seat, the following services can be operated: remote-control operation of a portable terminal device; setting and control of the air conditioner 33 by using setting information stored in a portable terminal device; reproduction of contents such as music stored in a portable terminal device; and seat position (including angle) control by the vehicle body controller 34 by using setting information stored in a portable terminal device.

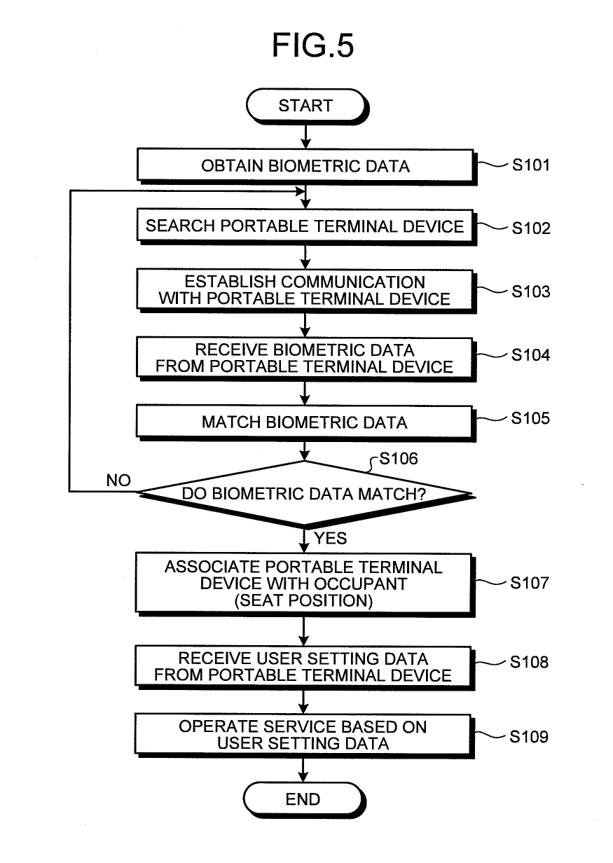

Operations of the occupant authentication apparatus 10 are explained next with reference to FIG. 5. A flowchart shown in FIG. 5 is started when a power-supply state of a vehicle is turned to an accessory (ACC) on-state.

When the process is started, the biometric-data obtaining unit 12 first obtains biometric data (Step S101). The communication processor 11 searches a portable terminal device (Step S102), and establishes communication with the portable terminal device (Step S103). Thereafter, the communication processor 11 receives biometric data from the portable terminal device (Step S104), and the matching unit 13 matches the biometric data (Step S105).

When the biometric data does not match stored biometric data as a result of matching (NO at Step S106), the process returns to the searching of a portable terminal device (Step S102) again, and another communication terminal device is searched. On the other hand, when the biometric data matches stored biometric data as a result of matching (YES at Step S106), the portable terminal device is associated with an occupant (in other words, a seat position) (in other words, through this process, a portable terminal device storing biometrics information of an occupant present at a certain seat position is specified as a portable terminal device of this occupant) (Step S107).

The occupant authentication apparatus 10 receives user setting data from the portable terminal device (Step S108), operates a service based on the user setting data (Step S109), and finishes the process.

As explained above, the occupant authentication apparatus 10 according to the first embodiment associates a user (i.e., an occupant) with a portable terminal device by using biometrics information (in other words, specifies the user and its corresponding portable terminal device). Therefore, when plural terminal devices that can be connected for communication are present, an in-vehicle device can automatically recognize which data owned by which terminal device should be used.

Because authentication information (i.e., biometrics information) does not need to be registered in advance at an in-vehicle device side (i.e., the occupant authentication apparatus 10 side), user information can be reflected to a vehicle setting by using a coordination function between a portable terminal device and an in-vehicle device even when a rental vehicle or the like is used. Therefore, the data stored for the vehicle at the portable terminal device side can be sufficiently utilized.

The first embodiment has an advantageous effect in that it is possible to provide a biometrics information matching apparatus, a biometrics information matching system, and a biometrics information matching method capable of associating a user with a portable terminal device by using biometrics information.

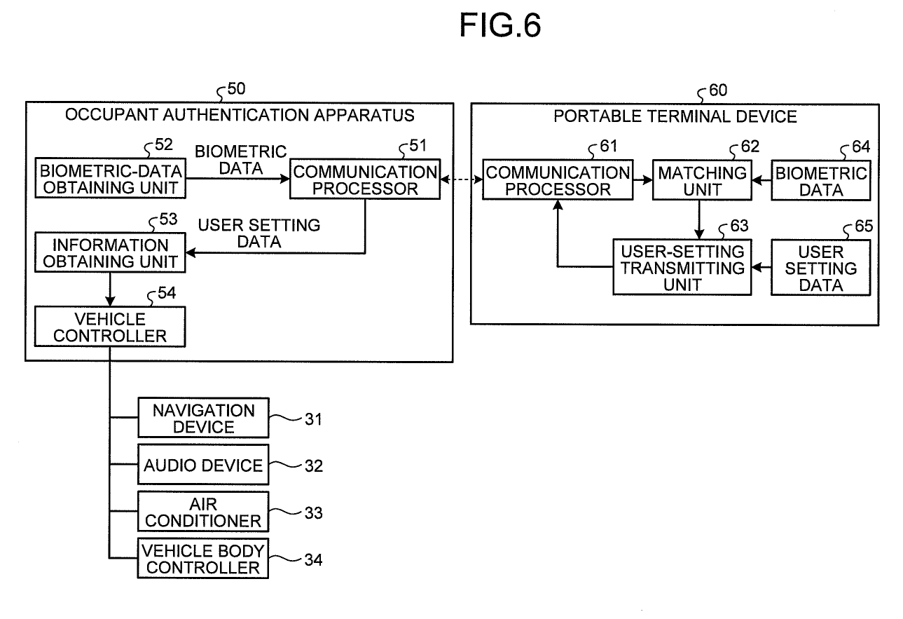

FIG. 6 is a schematic configuration diagram of a biometrics information matching system according to a second embodiment of the present invention. The biometrics information matching system depicted in FIG. 6 is an in-vehicle device, and includes an occupant authentication apparatus 50 functioning as a biometrics information matching apparatus and a portable terminal device 60.

The occupant authentication apparatus 50 includes a communication processor 51, a biometric-data obtaining unit 52, an information obtaining unit 53, and a vehicle controller 54. The portable terminal device 60 includes a communication processor 61, a matching unit 62, a user-setting transmitting unit 63, biometric data 64, and user setting data 65.

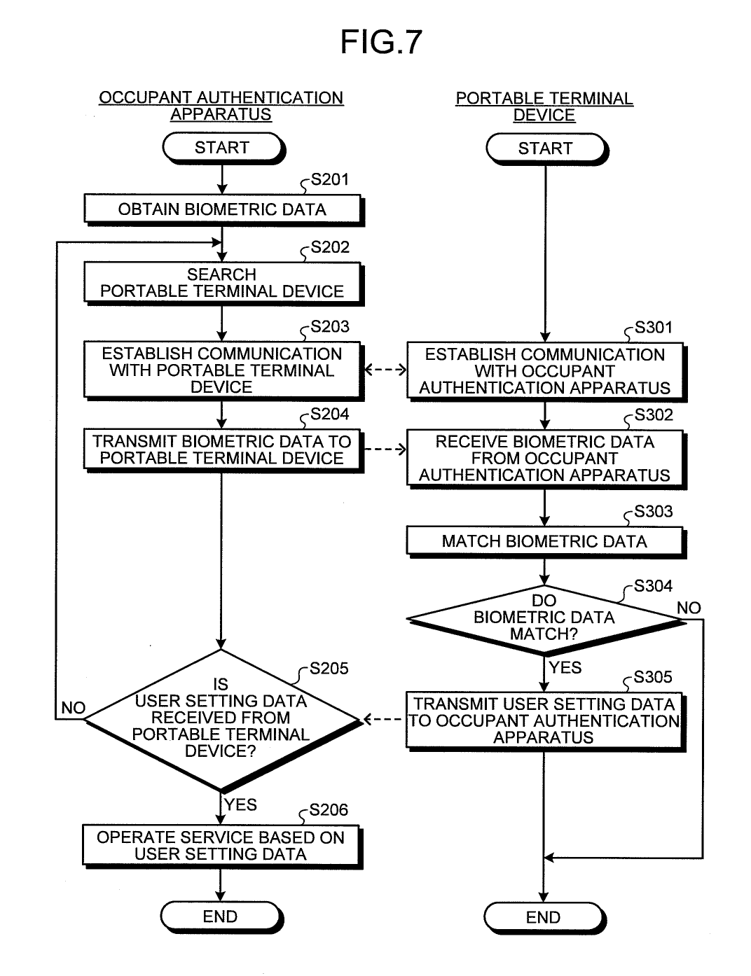

Operations of the biometrics information matching system depicted in FIG. 6 are explained with reference to FIG. 7. A flowchart of FIG. 7 is started when a power-supply state of a vehicle is turned to an ACC on-state.

When the process is started, the biometric-data obtaining unit 52 of the occupant authentication apparatus 50 obtains biometric data (Step S201). The communication processor 51 of the occupant authentication apparatus 50 searches a portable terminal device (Step S202), and establishes communication with the portable terminal device (Step S203). Thereafter, the communication processor 51 transmits biometric data to the portable terminal device (Step S204).

When the communication processor 61 establishes communication with the occupant authentication apparatus 50 (Step S301), the portable terminal device 60 receives biometric data from the occupant authentication apparatus 50 (Step S302). The matching unit 62 matches the received biometric data with biometric data held in advance (Step S303).

When the biometric data does not match the held biometric data as a result of matching (NO at Step S304), the portable terminal device 60 finishes the process. When the biometric data matches the held biometric data as a result of matching (YES at Step S304), the user-setting transmitting unit 63 transmits the user setting data 65 to the occupant authentication apparatus 50 (Step S305), and finishes the process.

At the occupant authentication apparatus side, after transmitting the biometric data to a portable terminal device (Step S204), if user setting data is not received from the portable terminal device (NO at Step S205), the process returns to the searching of a portable terminal device (Step S202), and another communication terminal device is searched.

On the other hand, when user setting data is received from the portable terminal device (YES at Step S205), a service based on the user setting data is operated (Step S206), and the process is finished.

As explained above, according to the biometrics information matching system of the second embodiment, matching is performed at the portable terminal device side. When biometric data matches held biometric data as a result of the matching, user setting data is transmitted to an in-vehicle device side. Therefore, at the in-vehicle device side, user setting data is received from only a portable terminal device of which biometric data matches the held biometric data, that is, a portable terminal device which is associated with an occupant, from whom the in-vehicle device obtains the biometric data.

The configurations described in the first and second embodiments are only exemplary, and the present invention is not limited thereto. The present invention can be also carried out by appropriately modifying these configurations within the technical scope of the appended claims.

For example, matching is performed at the in-vehicle device side in the first embodiment, and matching is performed at the portable terminal device side in the second embodiment. Alternatively, matching can be performed at both of the portable terminal device side and the in-vehicle device side, and an occupant and a portable terminal device can be associated with each other when biometric data matches both at the portable terminal device side and the in-vehicle device side.

The portable terminal device may be designed to be connectable by both a wired and wireless connection. In this case, when both connections are established, desirably, the wired connection is preferentially used.

The biometrics information matching system may be designed so that matching is performed only when the type of biometric data obtainable at the occupant authentication apparatus side is the same as the type of biometric data held (or obtainable) by the portable terminal device. Alternatively, the biometrics information matching system may be designed so that more than one type of biometric data can be used for matching. In this case, the type of biometric data to be used may be selected in advance.

Preferably, biometric data held at the portable terminal device side is periodically updated. Preferably, old biometric data is not used for matching.

As explained above, the biometrics information matching apparatus, the biometrics information matching system, and the biometrics information matching method according to the present invention are useful for matching biometrics information, and are particularly suitable for associating a portable terminal device with a user.

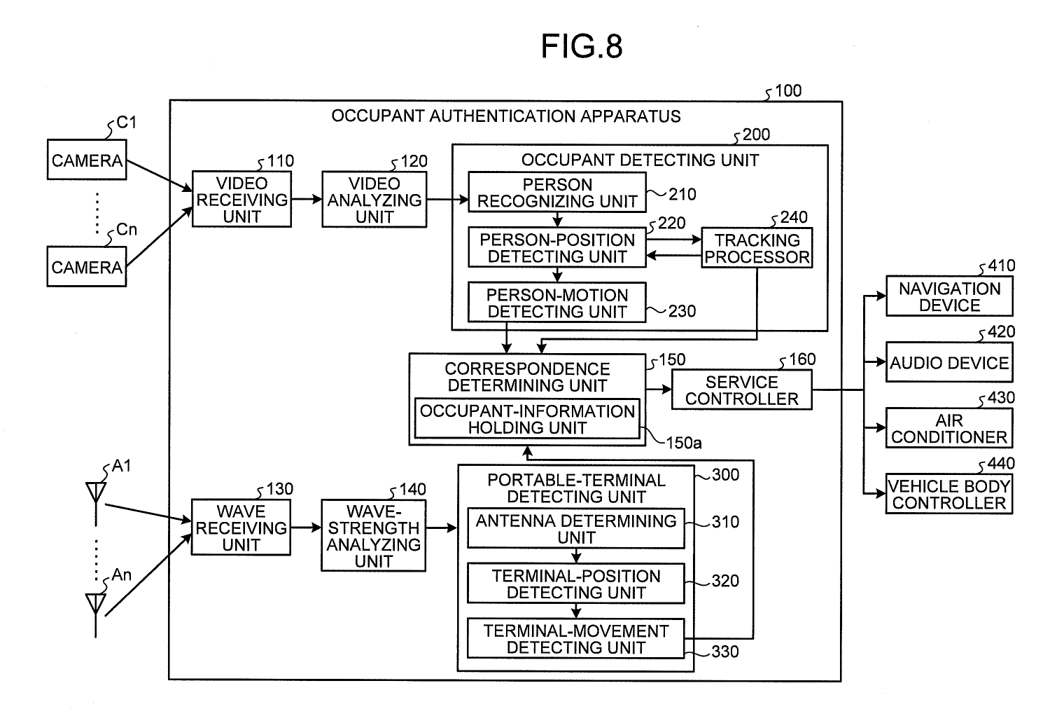

The occupant authentication apparatus is explained next with reference to FIG. 8. FIG. 8 is a schematic configuration diagram of an occupant authentication apparatus according to another embodiment of the present invention. An occupant authentication apparatus 100 depicted in FIG. 8 is an in-vehicle device incorporated in a vehicle, and is connected to cameras C1 to Cn, antennas A1 to An, a navigation device 410, an audio device 420, an air conditioner 430, and a vehicle body controller 440.

The cameras C1 to Cn are imaging units incorporated in a vehicle for imaging inside and outside of the vehicle. The antennas A1 to An are communication units incorporated in the vehicle for communicating with a communication terminal (for example, a portable telephone) inside and outside of the vehicle at a near distance (e.g., according to Bluetooth®, for example). In this case, if a single camera can image both inside and outside of the vehicle, one camera is enough. However, as for the communication unit, more than one antenna is arranged. This arrangement allows for specifying a position of a communication terminal by comparing the reception strengths at plural antenna positions.

The occupant authentication apparatus 100 includes a video receiving unit 110, a video analyzing unit 120, a wave receiving unit 130, an occupant detecting unit 200, a wave-strength analyzing unit 140, a portable-terminal detecting unit 300, a correspondence determining unit 150, and a service controller 160.

The video receiving unit 110 receives videos imaged by the cameras C1 to Cn, and delivers the received videos to the video analyzing unit 120. The video analyzing unit 120 analyzes the imaged videos received by the video receiving unit 110, specifies an image region in which an object is present, and outputs a result of specifying to the occupant detecting unit 200. The occupant detecting unit 200 performs an image recognition process to the output of the video analyzing unit 120, and detects a person.

Specifically, the occupant detecting unit 200 includes a person recognizing unit 210, a person-position detecting unit 220, a person-motion detecting unit 230, and a tracking processor 240. The person recognizing unit 210 identifies a region of an image of a person out of an image region output by the video analyzing unit 120. In this case, when characteristics of an image capable of specifying the person can be calculated, the characteristics are preferably calculated (usage of the characteristics of the person is described later).

The person-position detecting unit 220 is a processor that detects a position of a person recognized by the person recognizing unit 210. The position of the person can be detected by comparing a setting position of a camera that images the person, an imaging direction, the position of the person within an image, and a result of imaging by other cameras.

The person-motion detecting unit 230 is a processor that detects a motion of a person by recognizing a shape change of an image of a person from continuous images. The tracking processor 240 detects a movement of the person by recognizing a position change of an image of the person from continuous images. The result of the tracking is fed back to the person-position detecting unit 220.

The occupant detecting unit 200 outputs results of the above processes, that is, a result of recognizing a person, a result of detecting a position, a result of detecting a motion, and a result of a tracking process (result of a movement detection), to the correspondence determining unit 150.

The wave receiving unit 130 receives reception waves of the antennas A1 to An, and delivers the reception waves to the wave-strength analyzing unit 140. The wave-strength analyzing unit 140 analyzes reception strengths of the antennas obtained from the wave receiving unit 130, and outputs a result of the analysis to the portable-terminal detecting unit 300. The portable-terminal detecting unit 300 detects a portable terminal device based on the result of the analysis by the wave-strength analyzing unit 140.

Specifically, the portable-terminal detecting unit 300 includes an antenna determining unit 310, a terminal-position detecting unit 320, and a terminal-movement detecting unit 330. The antenna determining unit 310 discriminates between antennas, and obtains reception strength of each antenna.

The terminal-position detecting unit 320 is a processor that compares reception strengths of the antennas with each other, and detects a position of a portable terminal device. The position of the terminal device can be detected by performing a comparison by taking into account the setting position of an antenna that receives a wave from the terminal device and the receiving direction.

The terminal-movement detecting unit 330 is a processor that detects a movement of a terminal device based on transition of reception strength of each antenna.

The portable-terminal detecting unit 300 outputs a result of the above process, that is, a result of detecting a position of a terminal device and a movement state to the correspondence determining unit 150.

The correspondence determining unit 150 compares a position of a person output by the occupant detecting unit 200 with a position of a portable terminal device output by the portable-terminal detecting unit 300, and determines a correspondence between the person and the portable terminal device.

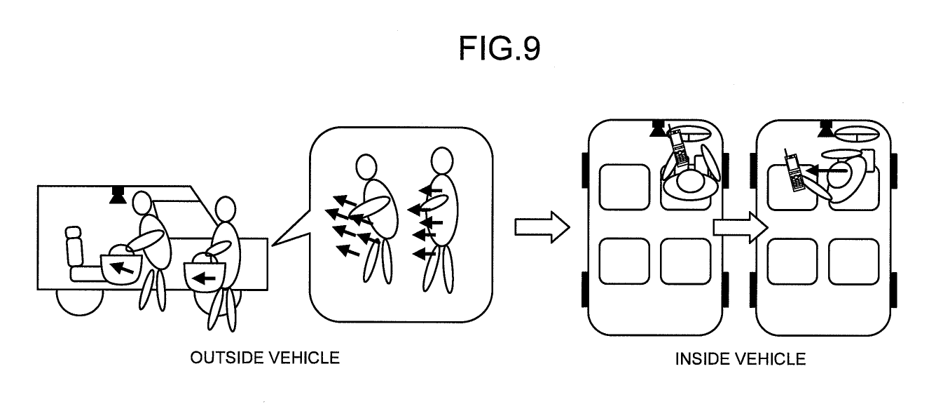

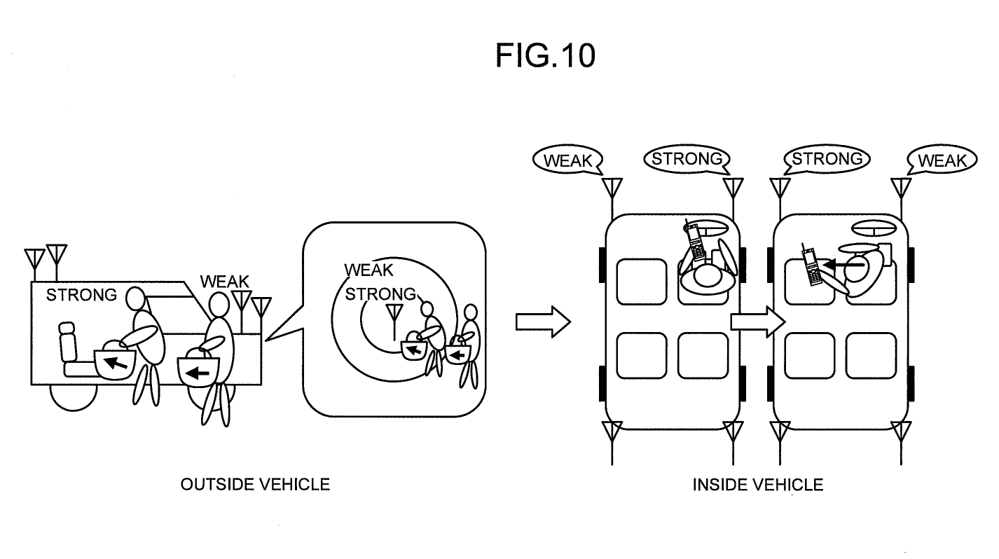

An outline of determination performed by the correspondence determining unit 150 is explained with reference to FIG. 9 and FIG. 10. A state that an occupant approaches a vehicle from the outside, enters the vehicle and is seated at a driving seat, and puts a portable telephone on a front passenger seat is explained by way of example.

First, as depicted in FIG. 9, the correspondence determining unit 150 recognizes a person by recognizing an image from a result of imaging by a camera that can image the outside of the vehicle among the cameras C1 to Cn, and detects a movement of the person (i.e., approach to the vehicle) by using an optical flow or the like.

After the person enters the vehicle, a motion of the person who puts a portable telephone on the front passenger seat is detected by using an optical flow of an image picked up by a camera that can image the inside of the vehicle among the cameras C1 to Cn.

At the same time, as depicted in FIG. 10, the antennas A1 to An communicate with the portable terminal device at respective positions. There is a difference between reception strengths of the antennas depending on a distance between the portable terminal device and each antenna. Therefore, a position of the portable telephone can be known from the strength of the reception wave of each antenna. A movement direction of the portable telephone can be obtained from a change of the wave strength according to the position of the portable telephone.

For example, as depicted in FIG. 10, when an occupant having a portable telephone approaches the vehicle, only one of the antennas nearest to the occupant reacts with a weak wave strength. Thereafter, when the occupant comes nearer to the vehicle, reception strength of each antenna becomes large.

After the occupant enters the vehicle, reception strength of the antenna at the driving seat side changes from strong to weak, and the reception strength of the antenna at the front passenger seat side changes from weak to strong. Consequently, it can be recognized that the portable telephone has moved from the driving seat to the front passenger seat.

Until the portable telephone leaves the person who owns the portable telephone, a position of the portable telephone substantially matches the position of the person. Therefore, the correspondence determining unit 150 determines that a person nearest to the portable telephone and whose movement direction matches a movement direction of the portable telephone is the owner of the portable telephone.

After determining the owner of the portable telephone, the correspondence determining unit 150 stores a correspondence between the portable telephone and the person into an occupant-information holding unit 150a. Thereafter, the correspondence determining unit 150 tracks the person associated with the portable telephone through correspondence (the owner of the portable telephone) while the person is within an imageable range.

Therefore, even when the occupant goes out of the vehicle once and is seated at the driving seat again after putting the portable telephone on a back passenger seat by opening the door at the back seat, that is, even when the person moves from the position of the portable telephone and only the position of the person changes, it is always possible to monitor the position of the person as the owner of the portable telephone and maintain the correspondence between the person and the portable telephone.

The service controller 160 operates a service using the information held by the portable terminal device to the seat position of the person corresponding to the portable terminal device, by using a result of the determination by the correspondence determining unit 150, that is, the correspondence between the person and the portable terminal device.

Devices that are controlled by the service controller 160 are the navigation device 410, the audio device 420, the air conditioner 430, and the vehicle body controller 440, in this example.

The navigation device 410 specifies position information of an own vehicle by using a GPS artificial satellite or the like, guides the vehicle to a destination, and provides information concerning traffics and regions. The audio device 420 is an in-vehicle device that reproduces music data and video data, and receives a radio broadcasting and a television broadcasting. The air conditioner 430 is an in-vehicle device that executes air-conditioning such as cooling and heating of the vehicle interior. The vehicle body controller 440 is a device that controls various in-vehicle devices to adjust a seat position, angle and a height of a seat, and angle of a room mirror and side mirrors, for example.

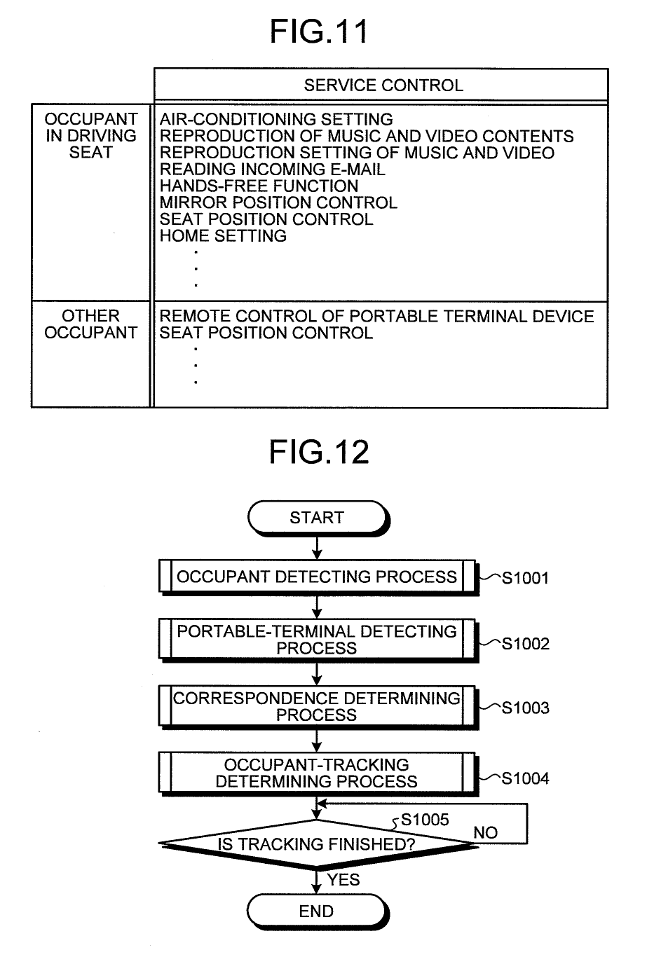

The service controller 160 controls these in-vehicle devices, and provides services as illustrated in FIG. 11. As shown in FIG. 11, the service controller 160 can provide the following services to the occupant in the driving seat: setting and control of the air conditioner 430 using the setting information stored in the portable terminal device; reproduction by the audio device of contents such as music stored in the portable terminal device; changing the setting of reproduction of music and videos; reading incoming e-mails of the portable terminal device; performing the hands-free communication function; mirror position control and seat position (including angle) control by the vehicle body controller 440 using the setting information stored in the portable terminal device; and transmission of a home location stored in the portable terminal device to the navigation device 410.

Furthermore, services to be provided to occupants other than the occupant in the driving seat include the following: remote control of the portable terminal device; setting and control of the air conditioner 430 using the setting information stored in the portable terminal device; and seat position (including angle) control by the vehicle body controller 440 using the setting information stored in the portable terminal device. The service controller 160 can also perform reproduction by the audio device of contents such as music stored in the portable terminal device, and changing the setting of reproduction of music and videos.

A process operation of the occupant authentication apparatus 100 is explained next with reference to FIG. 12. A flowchart illustrated in FIG. 12 is a main flow of the occupant authentication apparatus 100, and is a process performed repeatedly. Particularly preferably, the occupant authentication apparatus 100 is kept operated even when the vehicle is in a parked state, and occupant detection is performed when an occupant approaches.

First, the occupant detecting unit 200 performs an occupant detecting process (Step S1001), and the portable-terminal detecting unit 300 performs a portable-terminal detecting process (Step S1002).

When an occupant is detected by the occupant detecting process, and when a portable terminal device is detected by the portable-terminal detecting process, the correspondence determining unit 150 performs a correspondence determining process (Step S1003). Further, an occupant-tracking determining process is performed to an occupant for whom a correspondence is set (Step S1004). Tracking of the occupant is continuously performed until the tracking is determined to be finished (YES at Step S1005).

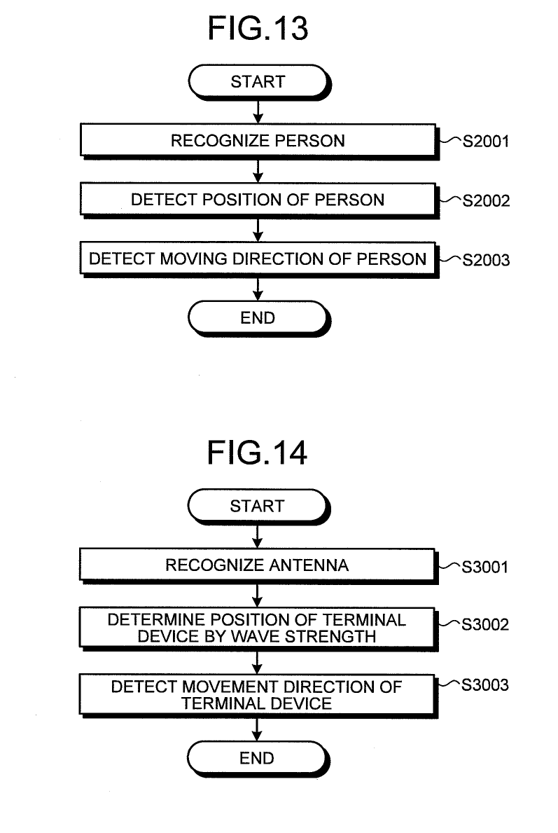

FIG. 13 is a flowchart for explaining a detail of the occupant detecting process. As shown in FIG. 13, the occupant detecting unit 200 first performs detection of a person by the person recognizing unit 210 (Step S2001), next detects the position of the person by the person-position detecting unit 220 (Step S2002), detects a motion of the person and a moving direction by the person-motion detecting unit 230 (Step S2003), and finishes the occupant detecting process.

FIG. 14 is a flowchart for explaining a detail of the portable-terminal detecting process. As shown in FIG. 14, the portable-terminal detecting unit 300 first recognizes an antenna by the antenna determining unit 310 (Step S3001). Next, the terminal-position detecting unit 320 detects a position of a terminal device by wave strength of each antenna (Step S3002). The terminal-movement detecting unit 330 detects a movement direction of the terminal device from a change of the wave strength (Step S3003), and finishes the portable-terminal detecting process.

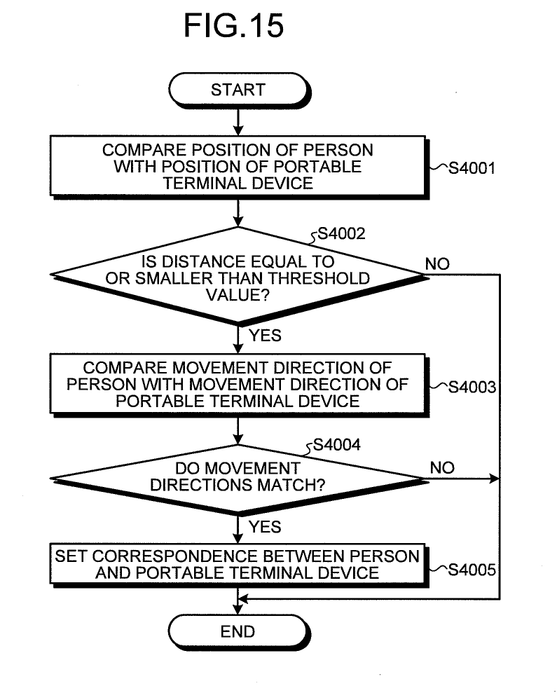

FIG. 15 is a flowchart for explaining a detail of the correspondence determining process. First, the correspondence determining unit 150 compares the position of a person with the position of a portable terminal device (Step S4001). As a result, when the distance from the position of the person to the position of the portable terminal device is equal to or smaller than a threshold value (YES at Step S4002), the correspondence determining unit 150 compares a movement direction of the person (moving direction) with a movement direction of the portable terminal device (Step S4003).

When the movement direction of the person matches the movement direction of the portable terminal device (YES at Step S4004), a correspondence between the person and the portable terminal device is set (Step S4005), and the correspondence determining process is finished. When the distance from the position of the person to the position of the portable terminal device is larger than the threshold value (NO at Step S4002), or when the moving direction of the person does not match the movement direction of the portable terminal device (NO at Step S4004), the correspondence determining process is finished.

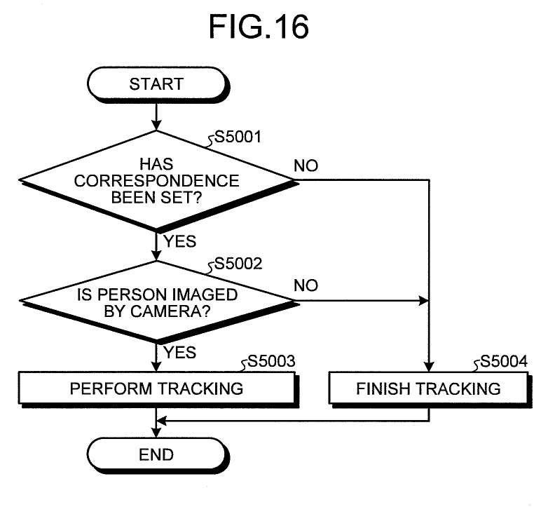

FIG. 16 is a flowchart for explaining a detail of the occupant-tracking determining process. The occupant detecting unit 200 determines to perform “tracking” (Step S5003) when a correspondence is set by the correspondence determining unit 150 (YES at Step S5001) and also when a person is imaged by a camera (YES at Step S5002).

On the other hand, when a correspondence is not set (NO at Step S5001) or when a person, for whom the correspondence is set, is not imaged by a camera (the person goes out of an imaging range of the camera) (NO at Step S5002), the occupant detecting unit 200 determines that “tracking is finished” (Step S5004).

A state that a person is imaged by the camera can be a state that the person is imaged by any one of cameras. Even when the person goes out of an imaging range of a certain camera, if the person is within an imaging range of another camera (for example, when the person goes out of an imaging range of a camera that images the outside of a vehicle and when the person enters an imaging range of a camera that images the inside of the vehicle), the tracking is continued by switching the camera.

As explained above, tracking of a person is finished when the person goes out of an imaging range of the camera. When characteristics of a person are calculated and held in advance as described above, a person who once goes out of the imaging range of the camera and returns can be recognized based on the characteristics, and the tracking can be continued. From the next time onwards, the personal authentication of the person can be performed by image recognition, and the personal authentication can be used to control the services and security operations.

When the system is configured to track a person until the person goes out of the imaging range of a camera, the tracking is continued during running of the vehicle after the person enters the vehicle. However, once the vehicle starts running, it is rare that a person moves within the vehicle. Therefore, the position of the person can be fixed when the vehicle starts running, and the tracking can be temporarily suspended or a tracking interval can be extended.

As explained above, in the occupant authentication apparatus 100 according to the above embodiment, the occupant detecting unit 200 detects the position of an occupant by image recognition, and the portable-terminal detecting unit 300 detects the position of a portable terminal device from reception strengths of plural antennas, and sets a correspondence by using the position of the person and the position of the portable terminal device. Therefore, the correspondence between the person and the portable terminal device can be automatically recognized, and data and functions held by the portable terminal device can be properly provided to a person, for whom the correspondence is recognized.

According to the present embodiment, it is possible to provide a person authentication apparatus and a person authentication method capable of automatically recognizing the correspondence between a person and a communication terminal and properly providing data and functions held by the communication terminal to a person, for whom the correspondence is recognized.

As described above, the person authentication apparatus and the person authentication method are useful for authenticating a person, and particularly suitable for setting a correspondence between portable terminal devices and users.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A biometrics information matching apparatus comprising:
a biometrics information obtaining unit that obtains biometrics information of an occupant;
a communicating unit that receives biometrics information stored in a terminal device by communicating with the terminal device, or biometrics information obtained by the terminal device;
a matching unit that matches the biometrics information obtained by the biometrics information obtaining unit with the biometrics information received by the communicating unit; and
an association setting unit that specifies that the terminal device is a terminal device of the occupant when two pieces of biometrics information match each other as a result of matching by the matching unit.

2. The biometrics information matching apparatus according to claim 1, wherein
the biometrics information obtaining unit is arranged at a position where a seat position of the occupant can be specified, and
the association setting unit specifies a seat position of the occupant.

3. The biometrics information matching apparatus according to claim 2, further comprising
a service operating unit that operates a service relevant to the terminal device to a seat position with which the terminal device is associated.

4. The biometrics information matching apparatus according to claim 1, wherein
the service operating unit obtains information relevant to a setting of a vehicle from the terminal device, and performs control of the vehicle based on the information.

5. A biometrics information matching system comprising:
an in-vehicle biometrics-information obtaining unit that obtains biometrics information from an occupant in a vehicle;
a matching unit that matches the biometrics information obtained from the occupant with biometrics information stored in a terminal device present in the vehicle or with biometrics information obtained by the terminal device; and
an association setting unit that specifies that the terminal device is a terminal device of the occupant when the two pieces of biometrics information match each other as a result of matching by the matching unit.

6. A biometrics information matching method comprising:
obtaining biometrics information from an occupant;
matching the biometrics information obtained from the occupant with biometrics information stored in a terminal device present in a vehicle or with biometrics information obtained by the terminal device; and
specifying that the terminal device is a terminal device of the occupant when the two pieces of biometrics information match each other as a result of the matching.

7. A person authentication apparatus comprising:
a person detecting unit that detects a person by image recognition;
a communication-terminal detecting unit that detects a communication terminal by radio communication; and
a correspondence determining unit that determines a correspondence between the person and the communication terminal by comparing a position of the person detected by the person detecting unit with a position of the communication terminal detected by the communication-terminal detecting unit.

8. The person authentication apparatus according to claim 7, further comprising
a service controller that operates a service using information held by the communication terminal to a position where the person corresponding to the communication terminal is present by using a result of determination by the correspondence determining unit.

9. The person authentication apparatus according to claim 8, wherein
the person is an occupant of a vehicle, and
the service controller controls at least one of change of a vehicle setting to a seat position of the person, a remote operation of the communication terminal by an in-vehicle input-output device, and reproduction output of data held by the communication terminal.

10. The person authentication apparatus according to claim 7, wherein
the person detecting unit further detects at least one of a movement and a motion of the person,
the communication-terminal detecting unit further detects a movement of the communication terminal, and
the correspondence determining unit further compares at least one of a movement and a motion of the person with a movement of the communication terminal, and determines the correspondence.

11. The person authentication apparatus according to claim 7, wherein
the person detecting unit tracks a movement of the person after the correspondence between the person and the communication terminal is set by the correspondence determining unit, and updates a position of the person.

12. The person authentication apparatus according to claim 7, wherein
the correspondence determining unit holds characteristics of an image of a person for whom the correspondence with the communication terminal is set.

13. A person authentication method comprising:
detecting a person by image recognition;
detecting a communication terminal by radio communication; and
determining a correspondence between the person and the communication terminal by comparing a position of the person detected with a position of the communication terminal detected.
